(19) United States
(12) Patent Application Publication
(10) Pub. No.: US 2026/0208883 A1
(43) Pub. Date: Jul. 23, 2026

(54) REACTIONLESS SPACE DRIVE BY INCREASING THE KINETIC ENERGY OF A DIRECTIONAL PLASMA FLOW WITH MAGNETOHYDRODYNAMIC FLOW ARRESTING

(71) Applicant: Randell L. MILLS, Newtown, PA (US)

(72) Inventor: Randell L. MILLS, Newtown, PA (US)

(21) Appl. No.: 19/142,085

(22) PCT Filed: Dec. 19, 2023
(86) PCT No.: PCT/US2023/084769

§ 371 Date: Jun. 20, 2025

Related U.S. Application Data
(60) Provisional application No. 63/434,870, filed on Dec. 22, 2022.

(51) Int. Cl. B64G 1/40; F03H 1/00

(52) U.S. Cl. CPC B64G 1/413; F03H 1/0093

(57) ABSTRACT

A reactionless means of propulsion involving conservation of photon energy absorbed by a free lepton such as a free electron. Specifically, conservation laws of a fundamental particle such as a free electron during photon absorption results in an increase in inertial parameters of inertial momentum and mass/energy corresponding to kinetic energy relative to absolute space with no reaction of a third body reaction partner in the exchange. In one embodiment, radiation such as microwave radiation, is absorbed by free electrons which gain kinetic energy along a preferential axis and may drag positive ions and a plasms flow. The electrons or plasma are incident a repulsive electrostatic field or rigid piston to transduce the kinetic energy into propulsion energy. Alternatively, the kinetic energy of the plasma is transduced into propulsion energy by a magnetohydrodynamic converter where plasma flow is arrested within a short distance in an MHD channel.

### RELATED APPLICATION

The present application claims priority to U.S. patent application Ser. No. 63/434,870, entitled SYSTEM AND METHOD FOR INCREASING THE KINETIC ENERGY OF A DIRECTIONAL PLASMA FLOW, filed on Dec. 22, 2022, the contents of which are herein incorporated by reference.

### SUMMARY OF THE INVENTION

The present invention is directed to a propulsion system, and more specifically is directed to a system and method for increasing the kinetic energy of a directional plasma flow, hereafter referred to as space drive or a space drive system, providing at least one of propulsion and lift to an object. The system of the present invention can include (i) at least one of a source of a directional plasma gas flow, a molecular beam, and a gas jet, (ii) a plasma generator such as a surfaguide plasma generator, a microwave generator or a microwave plasma discharge cavity, a plasma torch, or a source of ionization and a plasma chamber such as one comprising a refractory material transparent to microwaves such as a quartz tube to maintain a plasma and a directional plasma flow. The directional plasma flow can include electrons and ions and plasma gas, wherein the plasma and the directional plasma flow can include electrons and ions having an extended recombination half-life relative to a typical ion-electron recombination half-life (e.g. a hydrogen plasma comprising free electrons and trihydrogen cations (

$${H}_{3}^{+}$$

ions)). The system can also include (iii) at least one of a microwave generator, microwave cavity, horn antenna, or at least one microwave reflector to apply microwave power to ionized plasma electrons to create an increase in kinetic energy of at least one of the directional electron flow, directional plasma flow, and directional plasma gas flow, and (iv) at least one transducer to receive the directional kinetic energy and power and corresponding levitational or propulsion force from at least one of (a) the electrons that have absorbed the microwaves in a directional manner and gained reactionless kinetic energy in a directional manner, (b) the directional plasma flow comprising plasma electrons that have absorbed the microwaves in a directional manner and gained reactionless kinetic energy in a directional manner and transferred some of the directional kinetic energy to dragged plasma ions, or (c) the directional plasma gas flow. The plasma electrons that can absorb the microwaves in a directional manner and gain reactionless kinetic energy in a directional manner having at least one of (aa) transferred some of the directional kinetic energy directly to the plasma gas, (bb) indirectly transferred some of the directional kinetic energy to the plasma gas via dragged ions, or (cc) increased the kinetic energy inventory of the plasma gas flow via recombination of the increased-kinetic-energy electrons and ions. In one embodiment, the transducer transfers the received levitational or propulsion power and force to a desired object to be moved. The transducer can include (i) a negatively charged, repulsive electrode to repel electrons of the plasma flow to accept force from the directional electron flow, (ii) a magnetohydrodynamic (MHD) converter to arrest received plasma energetic electrons and ions of the plasma flow, and (iii) a piston to accept pressure from the plasma gas flow and recombined plasma flow.

In another embodiment, the space drive provides at least one of propulsion and lift and comprises (i) a first source of radio frequency or microwave power such as a radio frequency or microwave generator and a matching network, (ii) a surfaguide, a plasma chamber, a first microwave cavity, or a plasma torch powered by the first source of radio frequency or microwave power to maintain a hydrogen plasma comprising free electrons and

$${H}_{3}^{+}$$

ions, (iii) a source of radio frequency or microwave power such as a radio frequency or microwave generator that may comprise a second source or the first source and at least one of a microwave cavity that may comprise a second microwave cavity or the first microwave cavity, a horn antenna, at least one microwave reflector opposed to the horn antenna to apply microwave power to ionized plasma electrons to create an increase in kinetic energy of at least one of the directional electron flow, directional plasma flow, and directional plasma gas flow due to the free electrons absorbing the microwaves in a directional manner and gaining reactionless kinetic energy in a directional manner, and at least one of transducer such as negatively charged, repulsive electrode to repel energetic electrons that have absorbed microwaves in a directional manner and gained reactionless kinetic energy in a directional manner and transferred the corresponding stopping force to the object to be moved. Alternatively, the transducer may comprise an MHD converter to arrest received energetic electrons that have absorbed microwaves in a directional manner and gained reactionless kinetic energy in a directional manner and ions dragged by the energetic electrons and transfer the corresponding stopping force to the object to be moved. An exemplary MHD converter may comprise a linear or disc generator type. In another embodiment, the plasma may be incident a plasma and gas flow barrier that physically brakes or at least partially restricts the axial directional flows with the corresponding flow-retarding force on the barrier transferred to the object to be moved. This type of transducer is herein referred to as a piston transducer. To maintain the directional flow of the electrons that absorb the microwaves, the plasma cavity may comprise at least one gas channel in a direction at least partially perpendicular to the direction of the flow in which the microwave power was applied.

The space drive system can comprise a divergent gas flow channel and at least one vacuum pump to cause at least one of a pressure gradient and plasma gas recirculation for the flow of plasma gas and gas formed by ion and electron recombination due to the loss of kinetic energy due to the (a) electrode repulsion, (b) MHD plasma flow arresting, and (c) physical direction flow restriction by the barrier (piston).

The space drive system may further comprise at least one structural element attached to the transducer such as the repulsive electrode, MHD converter, or piston wherein the kinetic energy of the energetic electrons is transferred to the transducer to produce a lift or propulsion force on the at least one structural element supporting the transducer.

The space drive system may comprise a plurality of space drive units oriented along different axes to achieve the at least one of propulsion and lift in the corresponding selected directions.

The space drive system may further comprise a reorientation means such as a servomotor and a mechanical connection to cause at least one space drive system to tilt in a selected direction to achieve the at least one of propulsion and lift in that direction.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIGS. 1A-B are schematic drawings of a space drive system in accordance with an embodiment of the present disclosure.

FIG. 2A is a schematic drawing of an axial MHD converter with a permanent magnet in accordance with an embodiment of the present disclosure.

FIG. 2B is a schematic drawing of a disc type MHD converter with a racetrack-type magnet coil in accordance with an embodiment of the present disclosure.

FIG. 3 is a schematic drawing of a free electron in accordance with an embodiment of the present disclosure.

FIGS. 4A-F are schematic drawings of

$${H}_{3}^{+}$$

accordance with an embodiment of the present disclosure.

### DETAILED DESCRIPTION OF THE INVENTION

In an embodiment of the propulsion system of the present invention, herein called a space drive, an incident photon increases the kinetic energy of an electron by ½ of the photon energy given by ℏω wherein h is Planck's constant bar and ω is the photon angular frequency. The kinetic energy can be harnessed for propulsion or lift by directing the kinetic energized electrons toward a transducer, such as one that provides a repulsive field such as a negatively charged electrode, a plasma-flow-arresting MDH converter in the case that the electrons are plasma electrons, or a flow-retarding barrier or piston, whereby the repulsive or stopping forces are transferred to the structure supporting the transducer to cause translation or lift of the structure or an attachment to the structure. The classical theory regarding the nature of the photon and free electron that give rise to the reactionless force exploited herein as the mechanism of the “space drive” of the present disclosure is given in the R. Mills, The Grand Unified Theory of Classical Physics, April 2023 Edition, ISBN 979-8-218-17988-5, Library of Congress Control Number 2023905641, Chapter 4, the contents of which are herein incorporated by reference.

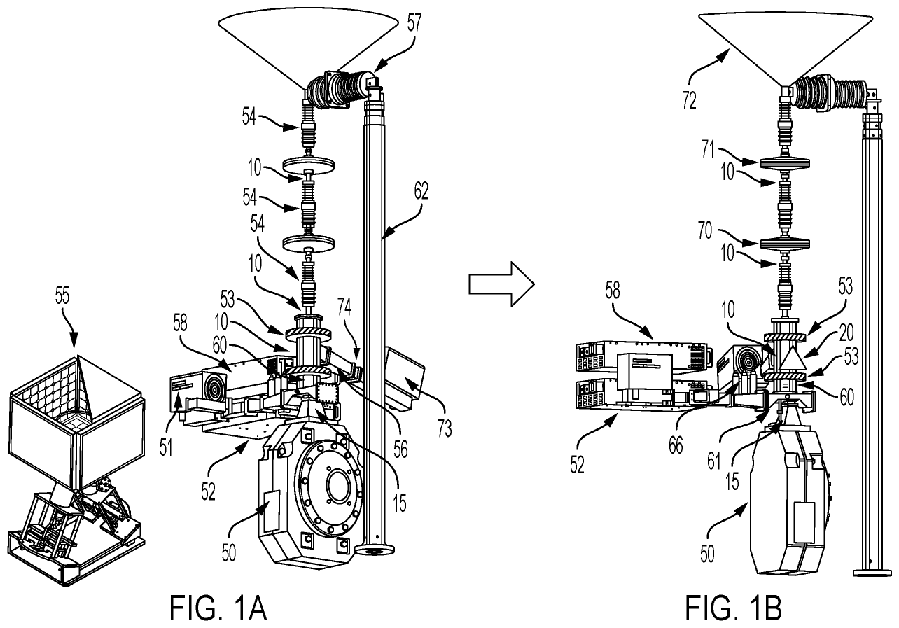

In an embodiment shown in FIGS. 1-4, the space drive comprises a directional beam of electrons or a directional flow of a source of electrons such as a gas beam, such as a hydrogen gas molecular beam. The electron beam or flow and gas beam or flow may be axial or linear. The molecular beam may be formed by expansion of high-pressure gas through a jet nozzle. In the illustrated embodiment, the plasma chamber can comprise a converging section connected to an outlet for plasma flow. The converging section, such as one comprising converging walls, can accelerate the plasm to form a jet along the axis of an axial plasma flow channel. The plasma chamber can comprise at least one of a converging nozzle and a converging-diverging nozzle, such as a Devall nozzle, to form the plasma jet. The molecular beam can comprise a supersonic molecular beam or jet.

The space drive can further include an ionization chamber that can create a directional flow of electrons from the molecular beam source. The ionization chamber may comprise a discharge chamber comprising a power source and a plasma generator, such as at least one of (i) a microwave plasma system such as one comprising a microwave generator, wave guide, tuning stubs, and at least one antenna such as a surfaguide plasma system, (ii) an inductively or capacitive coupled RF plasma generator such as one comprising an antenna coil or electrodes, (iii) a glow discharge system or subsystem comprising a power supply and at least two electrodes that are biased by the power supply, and (iv) a plasma created by a hydrino reaction such as one of atomic H catalyzed to hydrino atoms and molecules by H or HOH serving as the catalyst. In an embodiment, the discharge chamber forms a flow or beam of free electrons. The electron beam can further comprise a flow or beam of co-propagating position ions. In another embodiment, the space drive comprises an electron beam emitted from an electron gun. The space drive may further comprise a source of photons that are absorbed by the electrons of the electron beam or the flowing or propagating electrons such as those of a plasma such as a hydrogen plasma. The photon absorption may increase the electron kinetic energy of the electrons in their initial direction of travel.

The photon source can comprise at least one of a photon generator, a photon transmitter, a photon reflector, a waveguide, and/or a resonator cavity. The photon wavelength can be in the range of 10⁴ m to 10⁻¹² m. In an exemplary embodiment, the photon source can comprise a radio or microwave generator and transmitter that can include an antenna, such a horn antenna, and can further include a reflector to bounce un-absorbed photons between the source and the reflector to increase the efficiency of photon absorption by electrons upon which the photons are made incident. The antenna can polarize the microwaves. In an exemplary embodiment, the microwaves may comprise linearly polarized photons with the electric field parallel to the plane of the free electrons. In an alternative embodiment, the photon source may comprise a laser in any frequency range such as infrared to X-ray. The electrons can further drag positive ions of a plasma such that the kinetic energy inventory of the resulting flow comprises electron and positive ion kinetic energy and momentum. Since

$${H}_{3}^{+}$$

comprises ortho and para nuclear spin states and a free electron has a spin of ½, the cross section for the absorption of a photon by the free electron may be increased by coupling between the free electron spin and nuclear spins of a free-electron/

$${H}_{3}^{+}$$

ion pair based on the section rules for such transitions. A plasma comprising hydrogen is also favorable because of the long recombination lifetime of the tri-hydrogen cations with electrons which reduces plasma power loss due to recombination radiation and increases the ionization fraction and thereby maintaining a higher plasma electron inventory.

The propulsion system or space drive system can further include a drift channel or axial plasma channel and a repulsive-field means or a braking means to receive the kinetic energy inventory by braking at least one of the electron or plasma flow and the pressure due to the flow. The brake can include a rigid piston such as a closed chamber at the end of the electron drift channel or axial plasma channel. The braking means such as the rigid piston can be rigidly attached to an object to be propelled. In this case, the piston movement due to work on it may regard moving the object such as a craft rigidly connected to the rigid piston which may remain stationary or rigid relative to the craft.

Alternatively, the energetic electrons, energized by selective acceleration in the initial direction of motion by photon absorption, can flow into the drift channel and become incident on the repulsive field means. The repulsive field means can include a source of a repulsive electric field. The electric field of the repulsive field means can apply a repulsive force to the propagation of the electrons such that the electrons lose kinetic energy by transferring the energy to the repulsive field means or brake means. The repulsive field means can comprise at least one negatively charged electrode. The kinetic energized electrons can be directed towards the repulsive field means such as a negatively charged electrode and transfer the kinetic energy to the electrode. This process is called electron braking. The repulsive field or braking means can convert at least a portion of the electron and plasma kinetic energy to propulsion energy.

The energetic electrons can drag the corresponding molecular ions, such as

$${H}_{3}^{+}$$

ions. The electron-ion pairs can transfer kinetic energy to a collector by at least one of pressure-volume work and electron breaking. The electrons and hydrogen ions may recombine following the electrons working on the repulsive field means. The space drive can further comprise a pump to recycle the gas formed by recombination. In another embodiment comprising an electron beam, the electrons can be de-energized by transferring kinetic energy to the repulsive field means and may be collected in a beam dump and recirculated.

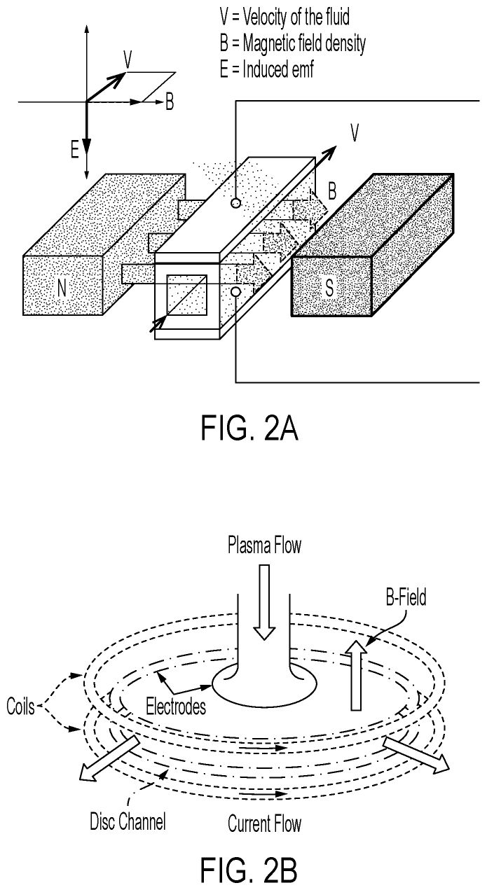

In an alternative embodiment, the space drive device can comprise a magnetohydrodynamic (MHD) converter. The MHD converter, shown in FIG. 2A, can comprise an axial channel for plasma flow, at least one set of magnets to apply a magnetic field across the axial channel having a component of the field direction perpendicular to the direction of plasma flow, channel electrodes oriented on the channel walls parallel to the plane of plasma flow velocity and the magnetic field that may further comprise capacitors or be electrically connected to capacitors, and a power controller and a power conditioner. In an alternative embodiment, as shown in FIG. 2B, the magnetohydrodynamic (MHD) converter of the space drive device can comprise a disc generator MHD converter comprising (i) opposing discs separated by a gap or disc channel and connected perpendicularly to the plasma flow channel and in connection with the plasma flow of the channel, (ii) at least one set of magnets to apply a magnetic field across the disc channel having a component of the field direction perpendicular to the direction of plasma flow in disc channel, (iii) and optionally two circular electrodes of opposite polarity radially separated in the disc channel wherein the electrodes may comprise at least one of a means to provide MHD power and at least one of capacitors and electrical insulators to allow charge and voltage to build up between the electrodes to arrest the plasma flow in at least one direction of axially along the axial channel and radially and azimuthally between the discs in the disc channel. The kinetic energy of the plasma can be transduced into propulsion energy by a magnetohydrodynamic (MHD) converter by being at least partially arrested in the at least one of the axial and disc channels.

The plasma flow may be axial and azimuthal in the axial and disc channels, respectively. The plasma such as one comprising electrons that have acquired kinetic energy by absorption of photons such microwave photons and dragged positive ions such as

$${H}_{3}^{+}$$

ions can be incident to the magnetic field with a component perpendicular to the velocity of the plasma flow corresponding to its kinetic energy. The velocity vector of the electrons and ions crossed with the magnetic field can result in a Lorentz force in the axis mutually perpendicular to the velocity and magnetic field vectors that separates the ions and electrons to produce a transverse MHD electric field and voltage. The Lorentz force can retard the plasma flow to convert plasma kinetic energy and power into propulsion energy and power, wherein the MHD conversion system may be structurally connected to a craft or object to be propelled by the propulsion energy and power. In one embodiment, the magnetic field and corresponding Lorentz force can be sufficiently strong or suitable to arrest the plasma flow within a desired axial length or radius of the MHD channel. The MHD voltage may be permitted to accumulate on at least one of a plurality of electrodes and capacitors of opposite polarity to reach a voltage that arrest the plasma flow. The MHD converter can include multiple stages to increase conversion of the kinetic energy into propulsion energy. In one embodiment, the MHD voltage can be at least partially harnessed for power to be recirculated to power the propulsion device, wherein the power can be controlled and conditioned by the MHD power controller and conditioner.

The source of magnetic field may comprise at least one of an electromagnet, permanent magnet, and/or a superconducting magnet. The magnetic field strength can be sufficient to arrest the plasma flow within the axial length of the magnetized MHD channel wherein the space-drive device may comprise a plurality of MHD channels along the plasma flow path. The relationship between the plasma flow velocity, MHD channel parameters, and magnetic field strength to arrest the axial plasma flow is given in the paper by Mills and Nansteel such as by Eq. (40) [R. Mills, M. W. Nansteel, “Oxygen and Silver Nanoparticle Aerosol Magnetohydrodynamic Power Cycle”, Journal of Aeronautics & Aerospace Engineering, Vol. 8, Iss. 2, No 216, (2019), pp. 1-13.], which is herein incorporated by reference in its entirety. In an embodiment, the arrest or stoppage of the plasma flow results in the conversion of at least a portion of the axial plasma kinetic energy into propulsion force and energy.

The arrest can further result in ion-electron recombination to form a neutral gas such as gaseous hydrogen. The gas formed by recombination at one or more stages of the MHD devices may be removed by a vacuum pump. In an embodiment, at least one of the axial and disc channels may comprise a pressure drop section such as one comprising at least one of an extended length section and a diverging section to allow the pressure of the gas formed by recombination to drop to maintain a pressure flow gradient in the channel from the plasma source such as the surfa wave source, microwave cavity source, or glow discharge source. The gas formed by recombination may be pumped from the pressure drop section by a vacuum pump. At least one of one or more stages or the MHD devices, and the pressure drop section may further comprise a gas line to an inlet to the vacuum pump or a plurality of vacuum pumps. In an embodiment, the vacuum pumps may recirculate the plasma gas such as hydrogen back to the plasma source such as the surfa wave source, microwave cavity source, or glow discharge source. In an embodiment, the space drive device may comprise a means such as a heat exchanger and cooler to remove the heat formed by the stoppage. The cooler may comprise at plurality of heat exchangers such as one to absorb heat from the MHD devices and the pressure drop section and deliver it to another heat exchanger such as a radiative or air-cooled heat exchanger that rejects the heat to ambient.

The electron and plasma kinetic energy may be harnessed for propulsion or lift. The repulsive forces of electron braking may be transferred to a structure supporting the electrode to cause translation or lift of a craft rigidly connected to the structural support.

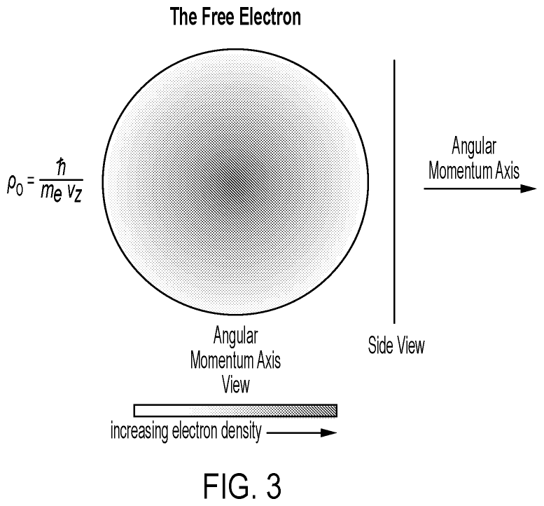

In an exemplary embodiment, as shown in FIGS. 1A-B, the space drive system comprises a source of a molecular beam or jet, a surfaguide plasma generator and a plasma chamber to maintain a hydrogen plasma flow comprising free electrons (FIG. 3) and

$${H}_{3}^{+}$$

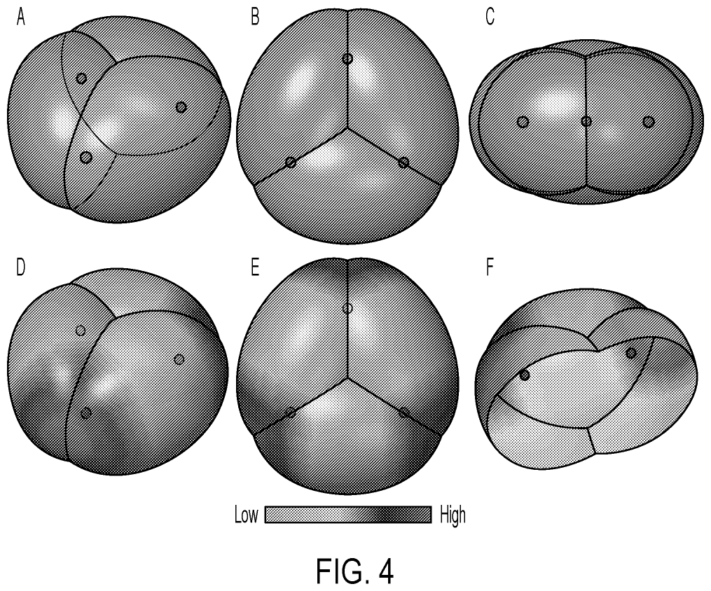

ions (FIGS. 4A-F), a microwave generator, a horn antenna, and at least one electrode capable of electrostatically breaking the plasma flow or an MHD converter capable of arresting the plasma flow.

The radio frequency photon absorption by the electrons of the plasma flow may cause the electrons to accelerate, and

$${H}_{3}^{+}$$

ions may be dragged with the accelerated electrons to a deliver kinetic energy to a thrust converter such as the electrostatic brake electrode or an arresting MHD converter or a physical flow retarding barrier that transfers electron and ion kinetic energy to the thrust converter and thereby to a craft rigidly attached to the thrust converter. With the kinetic energy transfer, electrons and the

$${H}_{3}^{+}$$

ions dragged with the accelerated electrons may recombine and the resulting H₂ gas may be recirculated to the plasma cavity 60.

At least one electrode may comprise a negatively charged, repulsive electrode to repel received energetic electrons that have absorbed microwave photons in a directional manner. At least one electrode may be negatively charged to repel the electrons. At least one electrode may comprise openings for electrons to flow through. At least one electrode may comprise a metal mesh grid electrode. The electrodes may be parallel. The electrode may comprise parallel plates. At least one of the parallel plate electrodes may comprise perforations for electrons to pass such as a parallel plate metal mesh grid electrode. In an embodiment, at least two electrodes may comprise a capacitor wherein the gas of the molecular beam may serve as the dielectric, or the dielectric may be absent. The repulsion force of the electrode(s) serves to brake the electron or plasma flow to convert the kinetic energy into propulsion energy.

In an alternative embodiment, the electrons of the hydrogen plasma comprising free electrons (FIG. 3) and

$${H}_{3}^{+}$$

ions (FIG. 4A-F) gain directional kinetic energy by absorption of photons such as microwave photons and the resulting energetic electrons are arrested in at least one of an axial and disc MHD channel to convert the kinetic energy into propulsion energy.

The kinetic energy of the electrons and plasma may be transferred to the repulsive electrode or MHD converter and cause lift to the structural elements supporting the electrode or MHD converter. The space drive system can comprise a plurality of units oriented along different axes to achieve drive in the corresponding selected direction. Alternatively, the space drive system may comprise at least one system with a reorientation means, such as a servomotor and a mechanical connection, such as a screw ring gear and a pinion servomotor gear or a rack and pinon connection to the servomotor, to cause the corresponding drive system to tilt in a selected direction to achieve drive in that direction.

Specifically, as shown in FIGS. 1A-B, the space drive system can be powered by a SunCell® 55, such as one comprising a magnetohydrodynamic or photovoltaic converter, that can reject excess heat through a radiative heat exchanger. An exemplary SunCell® can include a power system that generates at least one of electrical energy and thermal energy comprising:
a) at least one vessel comprising a baseplate capable of a maintaining a pressure below atmospheric comprising a reaction chamber; b) two electrodes each in fluid communication with molten metal contained in a corresponding reservoir, wherein the molten metal is configured to flow between the electrodes to complete a circuit; c) a power source connected to said two electrodes comprising a cathode and anode to apply an ignition current therebetween when said circuit is closed; d) optionally, a plasma generation cell (e.g., glow discharge cell) to induce the formation of a first plasma from a gas; wherein effluence of the plasma generation cell is directed towards the circuit (e.g., the molten metal, the anode, the cathode, each supplied molten metal by its molten metal reservoir), wherein when current is applied across the circuit, the effluence of the plasma generation cell undergoes a reaction to produce a second plasma and reaction products wherein energy from second plasma produces radiation; e) a transparent window cavity to transmit radiation produced from the second plasma, wherein the transparent window cavity is in contact with the baseplate of the vessel; f) a wet seal between the transparent window cavity and the baseplate comprising a wet seal molten metal; and g) a power adapter configured to receive the radiation transmitted through the transparent window cavity and convert and/or transfer energy from the second plasma into mechanical, thermal, and/or electrical energy.

The SunCell® systems may comprise those of the present disclosure or in Mills US patent applications such as Hydrogen Catalyst Reactor, PCT/US08/61455, filed PCT Apr. 24, 2008; Heterogeneous Hydrogen Catalyst Reactor, PCT/US09/052072, filed PCT Jul. 29, 2009; Heterogeneous Hydrogen Catalyst Power System, PCT/US10/27828, PCT filed Mar. 18, 2010; Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed PCT Jan. 10, 2014; Photovoltaic Power Generation Systems and Methods Regarding Same, PCT/US14/32584 filed PCT Apr. 1, 2014; Electrical Power Generation Systems and Methods Regarding Same, PCT/US2015/033165 filed PCT May 29, 2015; Ultraviolet Electrical Generation System Methods Regarding Same, PCT/US2015/065826 filed PCT Dec. 15, 2015; Thermophotovoltaic Electrical Power Generator, PCT/US16/12620 filed PCT Jan. 8, 2016; Thermophotovoltaic Electrical Power Generator Network, PCT/US2017/035025 filed PCT Dec. 7, 2017; Thermophotovoltaic Electrical Power Generator, PCT/US2017/013972 filed PCT Jan. 18, 2017; Extreme and Deep Ultraviolet Photovoltaic Cell, PCT/US2018/012635 filed PCT Jan. 5, 2018; Magnetohydrodynamic Electric Power Generator, PCT/US18/17765 filed PCT Feb. 12, 2018; Magnetohydrodynamic Electric Power Generator, PCT/US2018/034842 filed PCT May 29, 2018; Magnetohydrodynamic Electric Power Generator, PCT/IB2018/059646 filed PCT Dec. 5, 2018; Magnetohydrodynamic Electric Power Generator, PCT/IB2020/050360 filed PCT Jan. 16, 2020; Magnetohydrodynamic Hydrogen Electric Power Generator, PCT/US21/17148 filed Feb. 8, 2021; Infrared Light Recycling Thermophotovoltaic Hydrogen Electrical Power Generator, PCT/IB2022/052016, filed Mar. 8, 2022; and Infrared Plasma Light Recycling Thermophotovoltaic Hydrogen Electrical Power Generator, PCT/IB2023/053932, filed Apr. 18, 2023 (“Mills patent applications”), the contents of which are herein incorporated by reference in their entirety. The space drive system may comprise a molecular beam source or plasma gas flow source 50, and a plasma cavity 60, a plasma channel 10, and a means to brake or arrest and transduce kinetic flow of at least one of electrons and plasma for (i) the propagation of the molecular beam such as a supersonic hydrogen gas beam from the source 50 or a directional plasma gas flow from the source 50, (ii) the formation of plasma comprising free electrons and ions from the molecular beam or plasma gas, and (iii) the directional propagation or plasma flow of free electrons and ions that are irradiated and absorb electromagnetic radiation during the propagation to the a means to brake or arrest and transduce kinetic flow of at least one of electrons, ions, plasma, and plasma gas. The molecular beam source or plasma gas flow source 50 may comprise a source of gas such a hydrogen gas, a gas pump to achieve high gas pressure, a jet nozzle, values, pressure and flow sensors, and a control system, and a gas recirculation system to recover the gas once it has served to produce the desired work of the space drive. The gas pressure in at least the source 50, the plasma cavity 60, the plasma channel 10, and the transducer may be the range of about 1 microTorr to 100 atm. The gas recirculation system may comprise at least one gas pump, gas lines, flow and pressure sensors, and a controller. The molecular beam or plasma gas flow may be ionized in the plasma cavity 60. The cavity 60 may comprise a plasma generator such as a microwave plasma generator such as a surfaguide plasma or microwave cavity generator that may comprise a power supply 52, a microwave generator 51, a waveguide 61, and tuning stubs 66 to match the impedance of the load and the plasma cavity to the microwave waveguide and source. The frequency of the microwave generator 51 and dimensions of the cavity 60 may be selected to achieve a resonance between a mode of the cavity 60 having a high Q factor and the microwave frequency of the microwave generator 51.

The plasma, such as a hydrogen plasma, can be formed by the plasma generator such as by the surfaguide plasma generator 61, an exemplary generator is manufactured by Sairem. In an alternative embodiment, the plasma generator can comprise a microwave plasma system such as an atmospheric-pressure microwave plasma generator An exemplary atmospheric-pressure microwave plasma generator is one by Leins et al. [Martina Leins, Sandra Gaiser, Andreas Schulz, Matthias Walker, Uwe Schumacher, and Thomas Hirth, “How to Ignite an Atmospheric Pressure Microwave Plasma Torch without Any Additional Igniters”, J Vis Exp. 2015; (98): 52816; PMCID: PMC4541567, PMID: 25938699, the contents of which are herein incorporated by reference. A commercial version is available by Muegge Gerling, Gerling Applied Engineering, Inc., P.O. Box 580816, Modesto, CA 95358-0816, USA. The plasma may be accelerated to form a plasma jet or directional plasma flow by a plasma jet source or directional plasma flow 50.

In an embodiment, the microwave cavity 60 serves to maintain a directional ionized molecular beam or a directional plasma of the directional flowing plasma gas and may further irradiate the free electrons with microwave power such as microwave photons. The cavity may apply microwave power to ionized molecular beam or plasma electrons to create an increase in kinetic energy of at least one of the directional electron flow, directional dragged ion flow, directional plasma flow, and directional plasma gas flow due to the free electrons absorbing the microwaves in a directional manner and gaining reactionless kinetic energy in a directional manner. The increased electron kinetic energy may cause an increase in dragged ion kinetic energy and plasma gas kinetic energy. The ion-electron pair may comprise

$${H}_{3}^{+} + {e}^{-} .$$

In an embodiment, the plasma cavity 60 can include a thruster such as at least one of a Helicon, magnetohydrodynamic, electrostatic, or another thruster known in the art. The thruster can accelerate at least one charged species such as electrons or ions or a plasma such as a hydrogen plasma along the positive z-axis of the channel. In an exemplary embodiment, the thruster may accelerate an

$${H}_{3}^{+} + {e}^{-}$$

plasma beam along the positive z-axis of the channel.

The cavity 60 can connect to a plasma channel 10 that can further comprise magnets 53, such as permanent or electromagnets, such as Helmholtz coils, to at least one of magnetized, polarize, and provide confinement and axial flow of the free electrons of the plasma. In an exemplary embodiment, the Helmholtz coils comprise a magnetic bottle to provide confinement and axial flow of the free electrons of the plasma along the z-axis. The space drive system can further include (i) a plasma channel 10 connected to the plasma cavity 60 wherein at least one of electrons and plasma flow from the plasma cavity 60 to the plasma channel 10, (ii) a horn antenna 56, (iii) a microwave generator 73, and (iv) microwave power supply 58. The plasma channel 10 can further receive electromagnetic radiation such as microwaves from a source such as the horn antenna 56, microwave generator 73, and microwave power supply 58 to increase the free electron kinetic energy wherein the free electrons possessed an initial kinetic energy inventory in the direction of the molecular beam or plasma flow from the kinetic energy of the molecular beam or plasma flow. The plasma channel 10 may further comprise at least one RF or microwave reflector 20 on the opposite side of the plasma channel 10 from the horn antenna 56 to reflect RF or microwaves that are not absorbed by electrons back to the plasma channel 10 and horn antenna 56. The microwaves can be polarized in the plane of the electrons that can be aligned or polarized wherein the free electron alignment or polarization may be due to an applied magnetic field. The plasma channel 10 can further comprise a microwave waveguide to cause the microwaves from the source 73 and 56 to at least one of propagate in a desired direction and possess a desired polarization. In one embodiment, wherein the direction of propagation of the molecular beam, the free electron beam, plasma flow, and the plasma gas flow is defined as the z-axis (vertical in FIGS. 1A-B), the plane of the polarized electrons is the xy-plane with the electron angular momentum of h along the transverse z-axis. The microwaves may propagate in at least one direction such as along the y-axis and transverse to the z-axis.

In one embodiment, an

$${H}_{3}^{+}$$

beam or plasma flow can also be formed in the cavity 60 from the molecular hydrogen beam or plasma gas flow, and the

$${H}_{3}^{+}$$

beam or plasma flow may flow into the plasma channel 10. The electrons with increased kinetic energy from the incident microwave radiation from source 73 absorbed while propagating along the plasma channel 10 may drag the ions such as

$${H}_{3}^{+}$$

ions.

The free electrons can propagate from the cavity 60 through a drift channel 10 or plasma channel 10 to a force transducer anchored to a structural element that converts kinetic energy of the energized electrons to a force applied to the structural element such as the structure to which the transducer is anchored. Collectors such as Faraday cups and beam recirculators. Vacuum pumps may collect the electron beam and

$${H}_{3}^{+}$$

beam collision products wherein the products may be recirculated. Alternatively, the force transducer may comprise an MHD converter or a physical barrier/piston which act to arrest plasma flow or plasma gas flow, respectively.

The force of the energized electrons can be harnessed by at a series of conductive cavities or electrodes 70, 71, and 72 that receive the energized electrons to become charged to a voltage such as a high voltage such as one in the range of about 1 V to 100 MV. The voltage can provide a repulsive force against subsequent energized electrons of the beam reaching at least one repulsive cavity or electrode. Alternatively, the space drive may comprise a source of electrode voltage that may be applied to the electrodes to cause a repulsive force on the electrons to cause them to lose kinetic energy and transfer the energy to the at least one repulsive electrode. The repulsive force on the cavities or electrodes may be transduced to the cavities or electrodes and subsequently to a structure 62 to which they are anchored. The cavities or electrodes may be electrically insulated as in the case of a van der Graaf generator or Marx generator. To prevent arcing, the cavities or electrodes may be maintained in vacuum with separating electrical insulators 54 and 57 between member of a series of cavities or electrodes and from the structural support 62, respectively, wherein the drift channel 10 or plasma channel 10 penetrates through the insulators. The series of cavities or electrodes may comprise right cylinders (e.g. 70 and 71), each with a large radius to accept high charge, and may further comprise at least one inverted right conical cavity 72 that receives energized electrons at the cone apex. The sloped walls of the conical cavity may partially transduce a force along one axis such as the electron beam axis to a transverse axis corresponding to a transverse force component. The space drive may comprise a means to tilt at least one cavity or electrode 70, 71, and 72. In an embodiment, the conical cavity 72 may be tilted from being aligned on the electron beam axis to develop at least one force component in the direction of the tilted beam axis and along at least one axis transverse to the tilted beam axis.

In another embodiment, a means to brake or arrest at least one of the kinetic flow, kinetic and electrostatic momentum, kinetic energy, and pressure comprises a rigid piston 72 such as a closed cavity that may be diverging to increase the flow velocity by plasma expansion before being braked by the rigid piston.

In another embodiment, the repulsive field means can comprise at least two electrodes 70, 71, and 72 to provide a repulsive force on an electron beam or flow. The repulsive force on the electrons may be transduced to the electrodes and subsequently to the structure 62 to which the electrodes are anchored. One electrode may comprise a grid such as a metal mesh grid to allow electrons having kinetic energy to pass through the grid. The at least two electrodes may function in the opposite role as those of the Franck-Hertz experiment. In an embodiment shown in FIGS. 1A-B, the space drive comprises (i) an electron beam emitted by electron gun 50 further comprising an electron gun cathode to emit electrons to form the electron beam, (ii) an electron channel 10 for directional propagation of the electron beam in the channel, (iii) a means to apply microwave power to the electrons of the beam directionally propagating in the channel 10 to create an increase in kinetic energy of the directional electron flow due to the free electrons absorbing the microwaves in a directional manner and gaining reactionless kinetic energy in a directional manner such as at least one of a microwave cavity 60, power supply 52, a microwave generator 51, a waveguide 61, and tuning stubs 66 and a horn antenna 56, microwave generator 73, and microwave power supply 58, and (iii) a repulsive field means comprises (a) a metal mesh grid electrode 70 with a positive bias to draw electrons towards it, and (b) at least one negatively biased electrode 71 and 72 to provide a repulsive field to act on the electrons passing through the grid electrode 70. At least one of the electron-repelling electrodes 71 and 72 may comprise a metal mesh grid electrode.

An ionized molecular beam from molecular beam source 50 can replace the electron beam emitted by the electron gun. Specifically, in one embodiment, the molecular beam can be ionized to form a beam or flow of at least electrons and optionally ions such as

$${H}_{3}^{+}$$

ions, and the repulsive field means comprises (i) a metal mesh grid electrode or anode 70 with a positive bias to draw electrons towards it and (ii) at least one negatively biased electrode or cathode 71 and 72 to provide a repulsive field to act on the electrons passing through the grid electrode 70. In one embodiment, the positive ions of the corresponding flow of ions and electrons may be at least partially repelled by the positively biased electrode 70. The voltage-drop across the at least two electrodes may be controlled by a voltage and current sensor and a controller to optimize the kinetic energy power transferred to the repulsive field means. Electron and ion currents may result in ion-electron recombination wherein the resulting gas may be recirculated to the molecular beam source 50 by a gas recirculation means.

In an embodiment, the space drive system may further comprise magnets to apply a magnetic field. The magnetic field may be along an axis that is about perpendicular to the axis of propagation of the positive ions and the electrons. In an embodiment, positive ions and electrons may be separated by the magnetic field that causes an opposite Lorentz deflection of the positive ions and negative electrons.

The space drive system or device is shown in FIGS. 1A-B and can include at least one magnetohydrodynamic (MHD) converter, such as disc type MHD converters 70 and 72, to convert plasma kinetic energy to propulsion energy. In an exemplary embodiment, the MHD device may comprise a linear or axial MHD channel such as an axial MHD channel having a square or rectangular cross section to propagate the flow of the plasma, a source of magnetic field transverse to the flow axis of the axial channel, and electrodes on the channel walls parallel to the magnetic field axis. In another exemplary embodiment, the MHD converter comprises a disc channel between the discs for plasma flow from the axial channel, a racetrack magnet to apply a magnetic field across the gap or disc channel in an orientation perpendicular to the disc faces, and radial inner and outer disc channel electrodes.

The MHD electrodes may comprise at least one of a means to provide MHD power such as a power controller and a power conditioner and may further comprise at least one of (i) capacitors or be electrically connected to capacitors, and (ii) and electrical insulators to allow charge and voltage to build up between the electrodes to arrest the plasma flow in at least one direction of axially along the axial channel and radially and azimuthally between the discs in the disc channel. The kinetic energy of the plasma may be transduced into propulsion energy by a magnetohydrodynamic (MHD) converter by being at least partially arrested in the at least one of the axial and disc channels. The MHD magnets may be provide a sufficiently strong to cause the desired plasma flow arrest.

The gas formed by recombination at one or more stages of the MHD devices may be removed by a vacuum pump. In an embodiment, at least one of the axial and disc channels may comprise a pressure drop section 72 such as one comprising at least one of an extended length section and a diverging section to allow the pressure of the gas formed by recombination to drop to maintain a pressure flow gradient in the channel from the plasma source such as the surfa wave system or microwave cavity system.

The space drive may be oriented with the electron beam axis in the direction of the desired force. The space drive system may comprise a plurality of space drive units oriented along different axes to achieve drive in the corresponding selected directions. The space drive system may comprise a reorientation means to cause at least one space drive system to tilt in a selected direction to achieve drive in that direction. A plurality of space drives may be distributed among a plurality of locations of a craft. A representative distribution is at the apices of a triangular craft that has the feature of being an optimal design for transverse directional maneuverability of a triangular leading-edge airfoil design. Other desirable symmetrical geometries for craft are cylindrical, disc, and spherical. The craft may be caused to spin by methods and means such as by sequentially activating space drive units at different locations and orientations to cause it to wobble and then spin. The spinning motion may average out the forces of a plurality of units to achieve greater lift stability. The centrifugal force created by the spinning may serve as a replacement for gravity in the case of molten metal return flow of the SunCell power generator. In an embodiment, the Suncell may be secured to a gimbal that is caused to spin to create the return flow centrifugal force.

In another embodiment shown in FIGS. 1A-B, the space drive comprises a plasma maintained by a plasma excitation system. The plasma excitation system may comprise a plasma tube or cavity 60, electrodes, and an electrode power supply such as a glow discharge plasma system. Alternatively, the plasma excitation system may comprise an electrode-less discharge system. Four exemplary distinct types of excitations for electrode-less discharges are (i) inductive (magnetic field) discharges, (ii) capacitive (electric field) discharges, (iii) microwave discharges, and (iv) travelling wave discharges each comprising a system known in the art. In an exemplary embodiment of the capacitive discharges, a surface wave is propagated along the plasma column using a capacitive coupling in which there is an intense field between the ground plane and a conductor ring such as a copper ring placed around the tube. In another exemplary embodiment, the surfaguide is a device that can be used as a plasma source that comprises a simple surface-wave launcher in which a waveguide device can propagate a surface wave along the tube for plasma discharge. The main advantages of surfaguide with respect to other plasma sources are the possibility of using the GHz frequencies such as a frequency of 2.45 GHz wherein at this frequency, high power is available at low cost. In a further exemplary embodiment, the space drive system comprises at least one of an RF or microwave generator 50 with matching network 15, a gyrotron 50, and a surfaguide or surfawave launcher 50 to supply electromagnetic power to gas in the cavity 60 to at least one of maintain a plasma such as a H₂ plasma in the cavity and apply electromagnetic power to ionized plasma electrons to create an increase in kinetic energy of at least one of the directional electron flow, directional plasma flow, and directional plasma gas flow due to the free electrons absorbing the microwaves in a directional manner and gaining reactionless kinetic energy in a directional manner. The plasma cavity may comprise a tube such as a dielectric tube such as a quartz tube 60 that may be inserted through the waveguide 61. The cavity 60 may comprise a plasma generator such as a surfaguide plasma generator that may comprise an RF or microwave generator 50, a waveguide 61, and a matching network 15 to match the impedance of the load and the plasma cavity to the microwave waveguide 61 and source 50.

In an embodiment, the space drive system may comprise at least one electromagnetic power generator 50 to output electromagnetic radiation such as at least one of a radio wave and microwave generator. The radio waves may comprise electromagnetic radiation with wavelengths in the electromagnetic spectrum longer than infrared light. The microwaves may comprise electromagnetic radiation with wavelengths ranging from about one meter to one millimeter corresponding to frequencies between 300 MHz and 300 GHz, respectively. The radio wave generator may further comprise a matching network 15. The matching network 15 may output to a transmission line 61 or a radio wave or microwave guide or cavity 61. The guide or cavity 61 may provide electromagnetic power to at least one of maintain a plasma such as a hydrogen plasma and excite linear directional translation of free electrons that absorb the corresponding electromagnetic photons. The electromagnetic power may comprise photons that may be absorbed by free electrons to increase the free electron kinetic energy.

The waveguide or cavity 61 can comprise a multi-modal cavity such as a bimodal waveguide or cavity. The waveguide or cavity 61 can comprise a section with smaller dimensions such as a smaller channel height than at least one other section that may serve to intensify the radio or microwave power density. The waveguide can comprise a penetrating plasma tube 60 that is at least partially transparent to the radio or microwave wave maintained in the waveguide or cavity. Free electrons or a source of fee electrons may be flowed in the plasma tube. Source of free electrons may comprise hydrogen gas. The space drive system can include a source of plasma gas such as one comprising hydrogen gas such as the pure gas or a mixture form at least one of a noble gas such as argon, hydrogen, and water vapor. The space drive system may further comprise flow meters, regulators, valves, a vacuum pump, pressure gauges and controller, and other systems to supply a flow of plasma gas under a desired set of pressure and flow conditions such as a flow rate in about the range of 1 ml to 1000 liters per second and pressure in at least one range of about of 1 micro-Torr to 760,000 Torr and 100 mTorr to 2 atm.

The plasma cavity or tube 60 can have a connection to a plasma channel 10 along the positive z-axis. The plasma channel 10 may comprise a source of a magnetic field such as an axial field. The source may comprise a source of axial magnetic field such as Helmholtz coils 53 through which the plasma channel 10 may pass such as through the center of the coils. The axial magnetic field may comprise a pinch at one or more regions such as at the position of at least one Helmholtz coil 53. The source of magnetic field may further comprise a magnetic bottle wherein the highest energy electrons and ions pass in the z-axis direction. In an embodiment shown in FIG. 1, the magnetic bottle may be replaced by a thruster such as at least one of a Helicon, magnetohydrodynamic, electrostatic, or another thruster known in the art to accelerate an

$${H}_{3}^{+} + {e}^{-}$$

plasma beam along the positive z-axis of the channel.

The space drive can comprise a second electromagnetic power generator 73 to output electromagnetic radiation such as at least one of a radio wave and microwave generator. The radio waves may comprise electromagnetic radiation with wavelengths in the electromagnetic spectrum longer than infrared light. The microwaves may comprise electromagnetic radiation with wavelengths ranging from about one meter to one millimeter corresponding to frequencies between 300 MHz and 300 GHz, respectively. The radio wave or microwave generator may further comprise a matching network 74. The radio wave or microwave generator 73 or matching network 74 may output to a transmission line or a radio wave or microwave guide or cavity, or an antenna 56. The antenna such as a horn or strip antenna 56 may output at least one of directional and polarized radiation and radio wave or microwave photons. The plasma channel 10 may comprise a material at least partially transparent to the incident EM radiation such microwaves. In an exemplary embodiment, the channel may comprise a dielectric such as quartz or a ceramic such as one of the disclosure. The plasma in the plasma channel 10 may be incident and absorb radio wave power as RF or microwave photons from the second radio wave or microwave generator 73. An exemplary microwave frequency is in the range of 1 to 10 GHz. Microwave generator may comprise a magnetron, klystron, traveling-wave-tube (TWT), gyrotron, a solid state high power microwave source, and others known in the art. The antenna 56 may emit a directional beam of photons that are incident the plasma channel in a transverse direction such as along the x-axis in the case of a z-axis orient plasma channel. The space drive may comprise at least one reflector such as a radio wave or microwave reflector 20. Photons not absorbed by the transverse-oriented horn antenna may propagate to an opposing corner reflector 20 such as a dihedral or trihedral one. The reflector may reflect the photons back to the plasma channel 10 to be at least partially absorbed by the free electrons. The unabsorbed photons may propagate to the antenna 56 to be reflected to the channel to repeat a round trip reflection-absorption cycle between the antenna-plasma-channel-reflector. In an embodiment, the antenna such as the horn antenna 56 and reflector 20 such as dihedral or trihedral one may irradiate a substantial longitudinal portion of the drift or plasma channel 10 such as at least one of about 1% to 100% and 30% to 100%.

The RF or microwave reflector 20 comprising a main reflector such as a corner reflector opposed to the transversely oriented horn antenna such as a dihedral or trihedral one may further comprise a series of trihedral reflectors for side lobes azimuthally positioned with the main reflector at the center corresponding to the RF side lobes and main lobe respectively. The corner reflector is a passive device used to directly reflect radio waves back toward the emission source. In general, the corner reflector consists of mutually intersected perpendicular plates. Exemplary corner reflectors are dihedral and trihedral. While the dihedral corner reflector is sensitive to its mechanical alignment, the trihedral corner reflect is highly tolerant to misalignment. An exemplary trihedral corner reflector comprises three right angle plates.

The plasma cavity 60 may comprise any desired geometrical shape such as a right cylinder, sphere, polygon such as a rectangle, square or pyramidal cavity such as an equilateral pyramidal cavity comprising a plasma outlet at least one of the four equivalent apexes. The plasma cavity comprises a material that is transparent to at least one of radio and microwaves such as quartz, sapphire, MgF₂, glass, fused silica, alumina, zirconia, hafnia, magnesia, boron nitride, and other ceramics and radio and microwave transparent materials known in the art.

In one embodiment, the plasma excitation system to maintain plasma in cavity 60 may comprise a thruster such as at least one of a Helicon, magnetohydrodynamic, electrostatic, or another thruster known in the art to accelerate an

$${H}_{3}^{+} + {e}^{-}$$

plasma beam. The planar geometry of the free electron and

$${H}_{3}^{+}$$

may stabilize the corresponding ion pair to increase the free electron lifetime and increase the microwave photon absorption cross section.

The second electromagnetic power generator comprising a gyrotron 73 may produce microwave output at a frequency resonant with the magnetic field applied to the plasma of the plasma channel 10 such as a frequency resonant with the axial magnetic field applied by Helmholtz coils 53.

In an embodiment, the plasma channel 10 may be connected at an angle relative to the plasma chamber 60 to avoid inference or coupling of the radio waves or microwaves of the first electromagnetic radiation generator 51 and those of the second electromagnetic radiation generator 73 wherein the interference or coupling deceases the kinetic energy power of the plasma flow in the channel 10. In an embodiment, the connection between the plasma cavity 60 and the plasma channel 10 may be angled to provide better packaging of the assembly comprising at least one of the plasma cavity 60, plasma channel 10, and RF generator 50 with matching network 15. The wave guide, transmission line, or cavity 61 may be slanted to support a resonant electromagnetic cavity mode that is matched with the non-colinear plasma tube to plasma channel connection.

The photons emitted by the antenna 56 of the second electromagnetic power generator 73 such as the horn antenna of a microwave generator may comprise linear polarized photons. Each photon may have its electric field in the xy-plane. Alternatively, the incident photon may comprise a circular polarized photon. The polarization may be in the xy-plane.

### Exemplary Experimental Space Drive Embodiment for the Measurement of Directional Plasma Flow and Corresponding Force

Free electrons with a velocity in a vector direction will absorb microwave photons to be selectively accelerated in the direction of propagation. ½ of the energy of an absorbed photon is conserved as increased electron kinetic energy and ½ is conserved as an increased rotational kinetic energy that manifests as the invariant electron angular momentum of h and corresponding Bohr magneton of magnetic moment at a reduced de Broglie wavelength. In the case that the excited electrons comprise a plasma flow, the ions will be dragged by the electrons to increase the directional ion flow as well. Hydrogen plasma is a special case due to the extraordinary lifetime of H3+ ions. The corresponding directional kinetic energy can be evidenced by (i) an increase in pressure downstream of the excitation region, (ii) directional Doppler line broadening of recombining ions, (iii) increased electron kinetic energy as measured by an electron energy analyzer, Thomson scattering, or a Faraday cup, and (iv) a force transduced to the plasma chamber such as a thrust or lift force.

A plasma torch test disclosed infra. may be used to detect a directional upward force against gravity on a vertical or z-axis-oriented plasma chamber wherein free electrons of a plasma flow along the z-axis absorbs applied microwave radiation to increase the kinetic energy of the plasma flow in the z-direction.

The source of the plasma flow is an atmospheric gas flow plasma torch comprising a plasma tube having a gas inlet with a mass flow controller and a gas outlet at opposite ends of the plasma tube such as one comprising quartz, a pressurized plasma gas supply such as one comprising at least one of argon, hydrogen, and water vapor, and a plasma source such as a microwave plasma source comprising a microwave power source, a magnetron, an isolator, a circulator, power meter, a three stub tuner, and a tapered wave guide or a microwave cavity. Gas at a pressure above atmospheric pressure is flowed at mass-flow-meter-controlled high velocity through the inlet of tube inserted into the microwave cavity at the pre-acceleration end of plasma tube (PreAE). The plasma is accelerated by absorption of microwaves that increases the gas pressure towards the closed end of the plasma tube called the post acceleration end (PostAE). The consequential gradient of pressure from the PreAE to the PostAE creates a net force that pushes on the closed PostAE of the plasma tube. The PostAE comprises two side ports at relative 180° positions each with a smaller cross-sectional area than that of the PreAE end of the plasma tube. Each side port is connected by a channel to the PreAE of the plasma tube. The gas at higher pressure in the PostAE exits the side port at high velocity and flows at high velocity through the plasma torch and the microwave cavity to complete a closed loop wherein a steady net force is produced on the close PostAE due to the absorption of microwave photons with vector acceleration in the direction towards the PostAE. The opposing gas ports add zero net axial force. Alternatively, the force-cancelling side ports may vent to atmosphere with plasma gas flow provided by compressed gas. The net z-axis force due to the space drive effect may be measured using a scale with a system to balance the weight of the plasma chamber to increase the sensitivity of the force measurement.

Steps of a specific test:

Introduce high velocity gas flow at the bottom of a z-axis-oriented plasma tube freely housed in the microwave cavity.

Use a quartz T outlet at the top of the z-axis-oriented plasma tube to direct gas flow sideways in opposite directions at the T outlet such that there are no vertical or horizontal force.

Connect the bottom of the plasma tube freely housed in the microwave cavity on a scale partially weighted with the weight of the tube and gas line.

Connect the top of the tube to a pulley system with a water tank counterweight to the tube weight wherein the desired partial weighting of the scale is achieved by adjusting the amount of water in the counterweight.

Determine the increase in weight measured by the scale with the application of the microwave power due to an upward force on the plasma tube.

Note the dependence of the vertical force on the gas flow rate, pressure, and applied microwave power.

What is claimed is:

1.) A space drive system for providing at least one of propulsion and lift to an object, comprising
(i) at least one of a source of a directional plasma gas flow, a molecular beam, and gas jet,
(ii) a plasma generator to maintain a plasma and a directional plasma flow having electrons, ions and plasma gas,
(iii) at least one of a microwave generator, a microwave cavity, a horn antenna, and at least one microwave reflector to apply microwave power to ionized plasma electrons to create an increase in kinetic energy of at least one of the directional electron flow, directional plasma flow, and directional plasma gas flow, and
(iv) at least one transducer to receive the directional kinetic energy and power and corresponding levitational or propulsion force from at least one of (a) the electrons that have absorbed the microwaves in a directional manner and gained reactionless kinetic energy in a directional manner, (b) the directional plasma flow comprising plasma electrons that have absorbed the microwaves in a directional manner and gained reactionless kinetic energy in a directional manner and transferred some of the directional kinetic energy to dragged plasma ions, and (c) the directional plasma gas flow, wherein the plasma electrons that have absorbed the microwaves in a directional manner and gained reactionless kinetic energy in a directional manner have at least one of (aa) transferred some of the directional kinetic energy directly to the plasma gas, (bb) indirectly transferred some of the directional kinetic energy to the plasma gas via dragged ions, and (cc) increased the kinetic energy inventory of the plasma gas flow via recombination of the increased-kinetic-energy electrons and ions.

2.) The space drive system of claim 1, wherein the directional plasma flow comprises a plasma comprising the electrons and ions having an extended recombination half-life relative to a typical ion-electron recombination half-life (e.g. a hydrogen plasma comprising free electrons and trihydrogen cations
$$( {H}_{3}^{+}$$
ions)).

3.) The space drive system of claim 1, wherein the plasma generator comprises a surfaguide plasma generator, a microwave generator and microwave plasma discharge cavity, a plasma torch, and a source of ionization and a plasma chamber.

4.) The space drive system of claim 1, wherein the plasma chamber comprises a refractory material transparent to microwaves.

5.) The space drive system of claim 1, wherein the plasma chamber comprises a quartz tube.

6.) The space drive system of claim 1, wherein the transducer transfers the received levitational or propulsion power and force to a desired object to be moved wherein the transducer comprises at least one of (i) a negatively charged, repulsive electrode to repel electrons of the plasma flow to accept force from the directional electron flow, (ii) an MHD converter to arrest received plasma energetic electrons and ions of the plasma flow, and (iii) a piston to accept pressure from the plasma gas flow and recombined plasma flow.

7.) The space drive system of claim 1, further comprising i) a first source of radio frequency or microwave power, (ii) a surfaguide, a plasma chamber, a first microwave cavity, or a plasma torch powered by the first source of radio frequency or microwave power to maintain a hydrogen plasma comprising free electrons and
$${H}_{3}^{+}$$
ions, (iii) a second source of radio frequency or microwave power and at least one of a second microwave cavity, a horn antenna, at least one microwave reflector opposed to the horn antenna to apply microwave power to ionized plasma electrons to create an increase in kinetic energy of at least one of the directional electron flow, directional plasma flow, and directional plasma gas flow due to the free electrons absorbing the microwaves in a directional manner and gaining reactionless kinetic energy in a directional manner, and at least one of transducer of the group of (i) a negatively charged, repulsive electrode to repel energetic electrons that have absorbed microwaves in a directional manner and gained reactionless kinetic energy in a directional manner and transferred the corresponding stopping force to the object to be moved, (ii) an MHD converter to arrest received energetic electrons that have absorbed microwaves in a directional manner and gained reactionless kinetic energy in a directional manner and ions dragged by the energetic electrons and transfer the corresponding stopping force to the object to be moved, and (iii) a plasma and gas flow barrier that physically brakes or at least partially restricts the axial directional flows with the corresponding flow-retarding force on the barrier transferred to the object to be moved.

8.) The space drive system of claim 1, wherein the first and second source of radio frequency or microwave power comprises the same radio frequency or microwave generator and matching network.

9.) The space drive system of claim 1, wherein the first and second microwave cavities comprise the same microwave cavity.

10.) The space drive system of claim 6, wherein the MHD converter to arrest the plasma flow comprises a linear or disc generator type.

11.) The space drive system of claim 1, wherein the plasma cavity comprises at least one gas channel in a direction at least partially perpendicular to the direction of the flow in which the microwave power was applied to maintain the directional flow of the electrons that absorb the microwaves.

12.) The space drive system of claim 11, wherein the gas channel comprises a divergent gas flow channel and at least one vacuum pump to cause at least one of a pressure gradient and plasma gas recirculation for the flow of plasma gas and gas formed by ion and electron recombination due to the loss of kinetic energy due to the (a) electrode repulsion, (b) MHD plasma flow arresting, and (c) physical direction flow restriction by the barrier (piston).

13.) The space drive system of claim 1, further comprising at least one structural element attached to the transducer of the group of a repulsive electrode, MHD converter, or piston wherein the kinetic energy of the energetic electrons is transferred to the transducer to produce a lift or propulsion force on the at least one structural element supporting the transducer.

14.) The space drive system of claim 1, further comprising a plurality of space drive units oriented along different axes to achieve the at least one of propulsion and lift in the corresponding selected directions.

15.) The space drive system of claim 1, further comprising a servomotor and a mechanical connection to cause at least one space drive system to tilt in a selected direction to achieve the at least one of propulsion and lift in that direction.

16.) The space drive system of claim 1, further comprising a pressurized plasma gas source to provide a directional greater-than-atmospheric pressure plasma gas flow, a greater-than-atmospheric pressure plasma torch to maintain a directional plasma gas flow, an MHD converter to arrest the plasma flow following absorption of microwave photons by plasma electrons, a plasma recombination and plasma gas-expansion chamber and channel, and a plasma gas recirculator.

17.) The space drive system of claim 1, wherein the plasma gas comprises hydrogen or a source of hydrogen.
